(19) United States
(12) Patent Application Publication
(10) Pub. No.: US 2026/0072854 A1
(43) Pub. Date: Mar. 12, 2026

(54) LOW POWER 4:1 MULTIPLEXED RANK DUAL INLINE MEMORY MODULES

(71) Applicant: Intel Corporation, Santa Clara, CA (US)

(72) Inventors: Hussein ALAMEER, Hillsboro, OR (US); Saravanan SETHURAMAN, Portland, OR (US); James A. MCCALL, Portland, OR (US); Rajat AGARWAL, Portland, OR (US); Xiang LI, Portland, OR (US)

(21) Appl. No.: 19/389,041

(22) Filed: Nov. 14, 2025

Related U.S. Application Data
(60) Provisional application No. 63/868,435, filed on Aug. 22, 2025.

(51) Int. Cl. G06F 13/16; G06F 13/28

(52) U.S. Cl. CPC G06F 13/1647; G06F 13/287

(57) ABSTRACT

Disclosed herein is memory device that includes a printed circuit board (PCB) and a plurality of dynamic random-access memory (DRAM) devices arranged on the PCB and logically divided into four pseudo-channels. A shared command/address (C/A) bus of the device is configured to transmit command signals to all four pseudo-channels and a set of multiplexers on the device are controllable to selectively couple data signals between the four pseudo-channels and a memory controller. A control interface of the device is configured to interleave data burst transactions of the data signals across the four pseudo-channels, wherein a burst of the data burst transactions is distributed across two groups, each group comprising two of the four pseudo-channels operating in parallel.

### CROSS-REFERENCE TO RELATED APPLICATION(S)

This application claims priority to U.S. provisional application No. 63/868,435 filed on Aug. 22, 2025, the entire contents of which are incorporated herein by reference.

### BACKGROUND

As the demand for higher-performance computing with lower power continues to grow, there is a need for massive data throughput between the memory and the processors (e.g., central processing units (CPUs), graphics processing units (GPUs), tensor processing unites (TPUs), etc.). As applications continue to be developed, artificial intelligence (AI), big data analytics, machine learning, and databases require high-speed memory systems to handle the ever-increasing volumes and complexities of data. Advancements in cloud computing and machine learning algorithms are stretching the limits of current capabilities. AI applications hosted in the cloud rely on fast access and reduced latency in memory systems, which is amplified by an increasing number of processor cores. These AI applications require higher bandwidth memory systems with lower power, because power efficiency is often one factor in reducing operational costs and heat generation. Low-power (LP) memory technologies may also help keep total system power down without sacrificing performance. This may help improve the thermal profile of systems, enabling denser server packaging. The double-data rate 5 standard (referred to herein as DDR5 or DDR, and for low power, LPDDR5 or LPDDR) represents the current performance standard with respect to memory speed, bandwidth, and power efficiency.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a 4:1 multiplexing configuration of a 5×4 matrix of LPDDR5 x8 devices logically grouped into pseudo channels;

FIG. 2 illustrates an example printed circuit board (PCB) layout of a dual-sided dual inline memory module (DIMM) where the LPDDR5 devices of the quad chip attach (QCA) units are 4:1 multiplexed;

FIG. 3 depicts an example top view of the PCB of FIG. 2;

FIG. 4 shows another example of one side of a board (PCB) layout of a dual-sided DIMM that may use only 10 QCA packages;

FIG. 5 illustrates a wiring diagram for operating the two ranks of FIG. 1, where each rank includes 5×4 set of LPDDR5 x8 devices in QCA packages that are 4:1 multiplexed; and

FIGS. 6A, 6B, and 6C shows an example timing diagram of operating the 4:1 multiplexing configuration of a 5×4 matrix of LPDDR5 x8 devices logically grouped into pseudo channels;

FIG. 7 shows an example of 4:1 multiplexing configuration for burst length 32 (BL32), where each LPDDR5 x16 device forms a corresponding pseudo channel; and

FIG. 8 shows an example flow diagram of a method for interleaving two pseudo channels.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As noted above, there a need for increased memory speeds, higher bandwidth memory, and lower power over the currently available performance provided with DDR5 memory. A typical DDR5 implementation uses multiplexed dual ranks (a collection of memory chips on a dual inline memory module (DIMM)), where two devices in two different ranks may be multiplexed (MUXed) to provide higher bandwidth. As is understood, a rank refers to a group of DRAM chips that may respond to the same command but may provide data on separate data lines. In DDR5, each DIMM may be split into two independent subchannels, each subchannel having one or more ranks. While this form of multiplexed dual-channel ranking provides higher bandwidth, the power efficiency is low, and so the system consumes too much power in order to provide the higher bandwidth. In addition, there are scalability issues in the sense that there may not be a sufficient number of select lines on the multiplexer register clock driver (MRCD) chips, limiting the multiplexing to a maximum of 2:1 ranks. Scaling up in this manner would require a doubling of the existing data buffer chips, costing more and requiring too much additional power consumption.

As discussed in more detail below a new multiplexing configuration is disclosed herein that provides increased bandwidth at a reduced power that uses the currently existing standards for DDR5 connector and pin out. The lower power may be achieved by utilizing low-power dynamic random-access memory devices (LP5/LP5x technology DRAMs) behind the buffers. The disclosed multiplexing configuration may offer a 4:1 MUXing capability to provide more efficient operation as compared to the 2:1 MUXing available in multiplexed dual ranks of DDR5s, especially in burst length 16 (BL16) mode of operation. For example, low-power DDR5 (LPDDR5) operation in BL16 may have large inefficiency of approximately 50-70% due to command bandwidth (CMD BW) overhead in this mode. The disclosed multiplexing configuration uses 4:1 multiplexing to improve efficiency by interleaving two pseudo channels across the first BL16 followed by the other two pseudo channels interleaved across the second BL16, where each DRAM operates at half the frontside data rate.

The disclosed multiplexing configuration may provide for high bandwidth, high capacity and high speed, all at a lower power compared to conventional DDR5. The disclosed multiplexing configuration may be understood as a low power multiplexed rank dual inline memory modules (LPMRDIMM) that brings very high capacity such as 4 or 8-ranks capacity with 4:1 MUXing capability. The DRAMs may be operated at one quarter of the speed as compared to the front side of the DIMM which goes to memory controller. The disclosed multiplexing configuration may allow for more loading behind the buffer to reduce command and address copies. Even with these benefits, the multiplexing configuration may utilize existing DDR5 connector types because there is no need to modify the wiring and/or pinouts. Instead, the differences are internal to the memory, after the buffer.

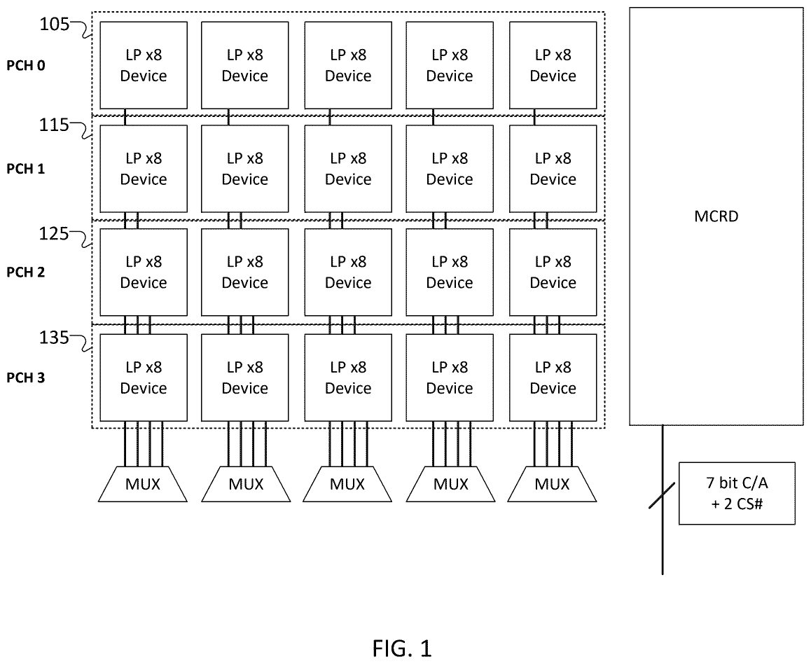

An example embodiment of the disclosed multiplexing configuration is shown in FIG. 1, where 4:1 multiplexing allows for interconnecting 4 or 8 ranks through the use of a set of two interleaved pseudo channels for a first burst and a second set of two interleaved pseudo channels for the second burst. FIG. 1 shows a 5×4 matrix of LPDDR5 x8 devices arranged in a vertical and horizontal stack, where the five LPDDR5 x8 devices in a horizontal group represent a pseudo channel (e.g., PCH0 is the top row of five devices 105, PCH1 is the second row of five devices 115, PCH2 is the third row of five devices 125, and PCH3 is the fourth row of five devices 135). The row of five multiplexers are connected to a common bus that allows selectively addressing each pseudo-channel. The 5×4 matrix and corresponding multiplexers may be understood as a rank, where each of the individual LPDDR5 x8 devices may operate at one-quarter of the full data rate, allowing the overall set of devices to operate at lower power with improved thermal characteristics (e.g., generates less heat). In BL16 mode, the bursts may be interleaved, mapping each half burst to different sets of two of the pseudo channels. The addressing may be through a 7 bit command address (C/A) over the multiplexing command bus (MRCD) bus with 2 chip selects (CS #) for identifying the pair of interleaving pseudo channels.

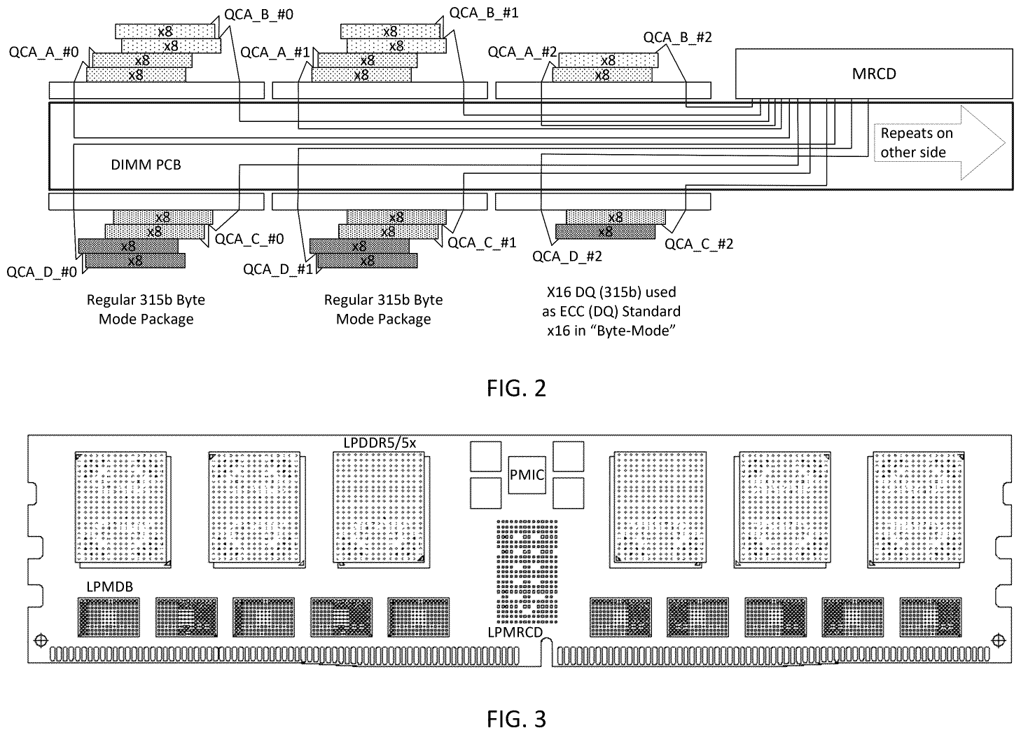

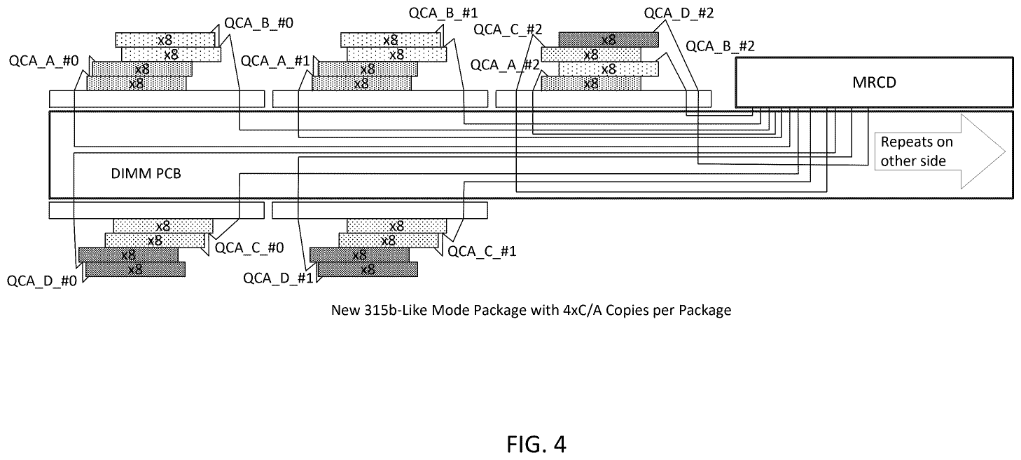

FIG. 2 shows one side of a board (PCB) layout of a dual-sided DIMM where the LPDDR5 devices of the quad chip attach (QCA, also called QDP (Quad-Die Package) or multi-die packages) units are 4:1 multiplexed through the MRCD in the manner shown in the block diagram of FIG. 1. As shown in FIG. 2, each pseudo-channel (PCH0, PCH1, PCH2, PCH3) corresponds to a QCA group (QCA_A, QCA_B, QCA_C, QCA_D) of the PCB, and is multiplexed through the common bus (7 bit C/A and 2 chip selects) of the MRCD. As should be understood, only one side of the PCB is shown in FIG. 2 and the structure may repeat on the other side. FIG. 3 shows a top view of the example PCB layout in FIG. 2.

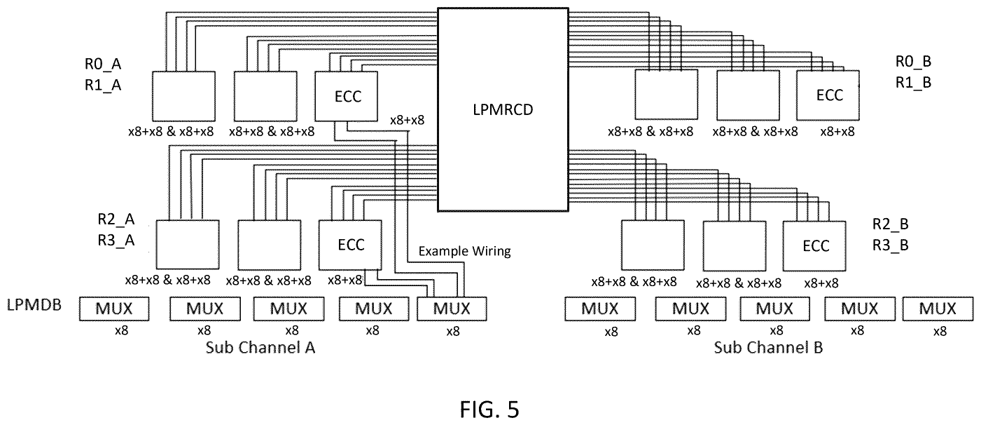

FIG. 4 shows another embodiment of one side of a board (PCB) layout of a dual-sided DIMM. In contrast to the layout of FIG. 2, only 10 QCA packages are needed as opposed to the 12 QCA packages that would be needed to implement the layout of FIG. 2. As should be understood, other layouts may be used depending on space constraints, cost constraints, chip count constraints, etc.

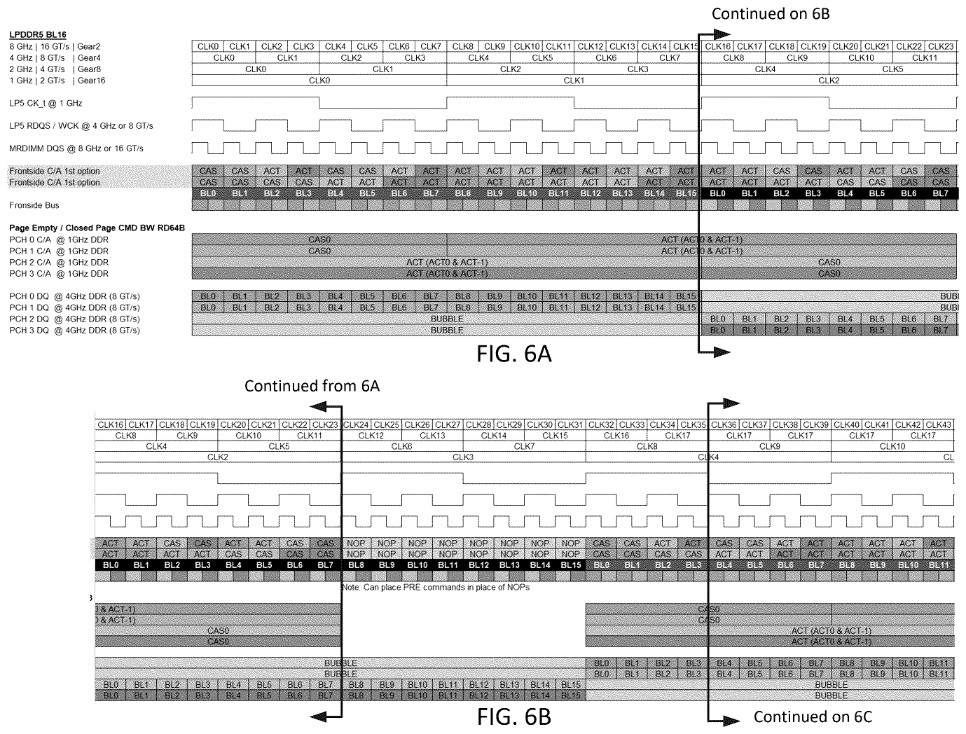

FIG. 5 shows a wiring diagram of two ranks (sub channel A and sub channel B), where each rank includes 5×4 set of LPDDR5 x8 devices in QCA units that are 4:1 multiplexed through the MRCD. Each of the pseudo channels of FIG. 1 (PCH0, PCH1, PCH2, PCH3) correspond to pseudo channels A-D of FIG. 5 and are represented as logical device groups: R0_A, R1_A, R2_A, R3_A for pseudo channel A; R0_B, R1_B, R2_B, R3_B for pseudo channel B; R0_C, R1_C, R2_C, R3_C for pseudo channel C; and R0_D, R1_D, R2_D, R3_D for pseudo channel D. The pinouts on the DIMM connector need not be modified from its normal pin out, but the backside of LPMRCD and LPMDB may have additional ranging from 1 to 1.5× and 2×.

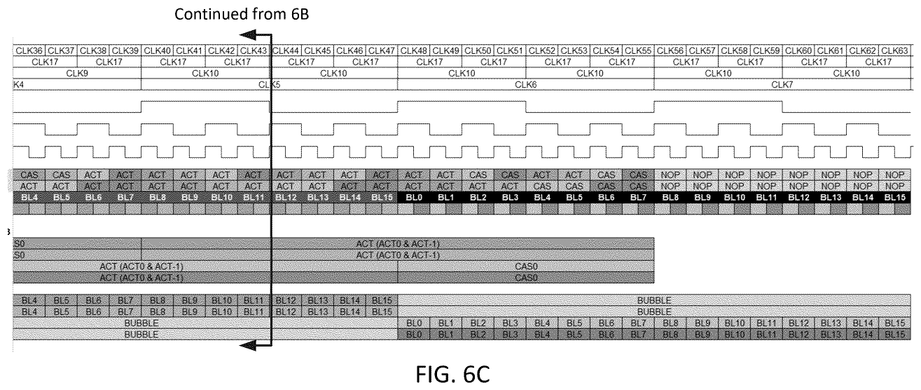

FIGS. 6A, 6B, and 6C shows a complete timing diagram for operating the two ranks of FIG. 5, where each rank includes 5×4 set of LPDDR5 x8 devices in QCA units that are 4:1 multiplexed, divided in time portions corresponding to each of FIGS. 6A, 6B, and 6C.

As mentioned above, conventional LPDDR5 operation in BL16 may have large inefficiency of ˜50-70% due to CMD BW overhead in this mode. The 4:1 mode multiplexing scheme discussed above may improve efficiency where two pseudo channels are interleaved across the first BL16 followed by the other two pseudo channels interleaved across the second BL16 with each DRAM operating at half the frontside data rate. This may be seen in the high level timing diagram across FIGS. 6A, 6B, and 6C.

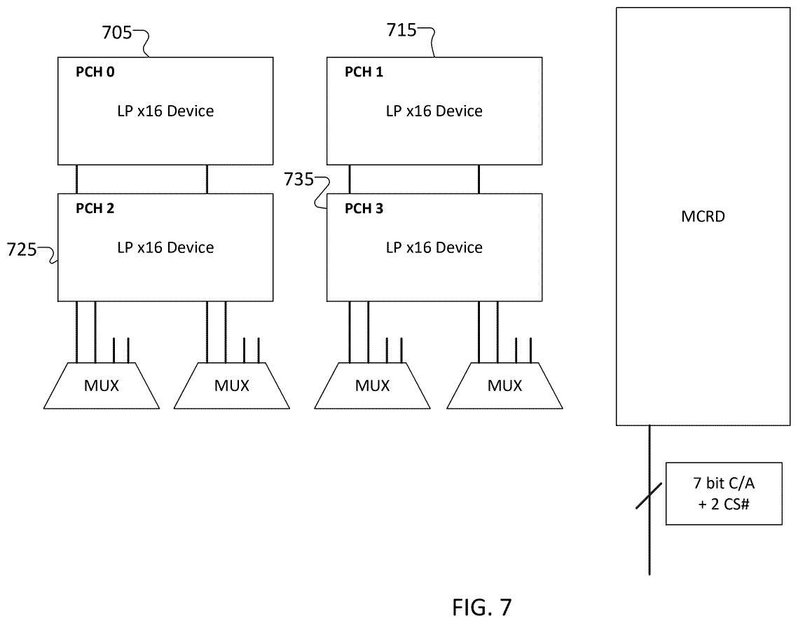

In addition, this 4:1 multiplexing scheme may be expanded to a BL32 mode of operation. This may involve reduced row address strobe (RAS) capability but may also show a two fold improvement in power efficiency. To achieve that, the pseudo-channel width is reduced from a 40-bit channel down to a 16-bit channel. An example of such a configuration is shown in FIG. 7, where each of channels PCH 0, PCH 1, PCH 2, PCH 3, and PHC 4 correspond to an LP x16 Device 705, 715, 525, and 735 respectively. This alternative mode may be advantageous when power savings is of particular importance, whereas a reduced RAS capability may be acceptable.

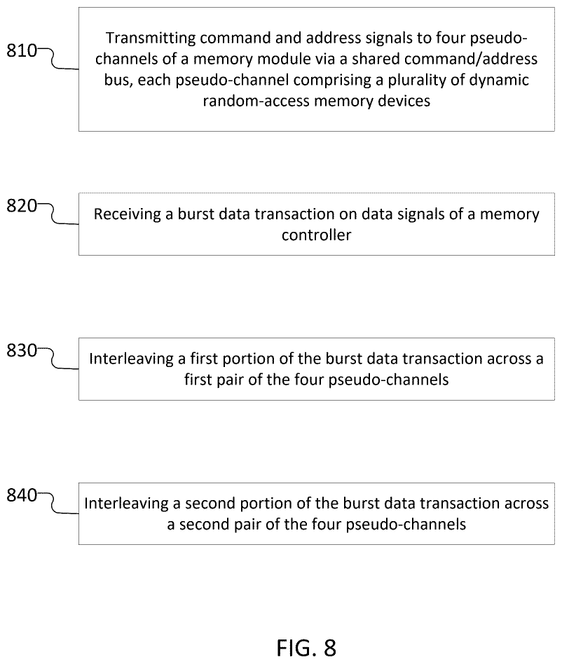

FIG. 8 depicts a schematic flow diagram of a method 800 for interleaving two pseudo channels. Method 800 may implement any of the features discussed above with respect to the interleaving of pseudo channels and/or FIGS. 1-7. Method 800 includes, in 810, transmitting command and address signals to four pseudo-channels of a memory module via a shared command/address bus, each pseudo-channel comprising a plurality of dynamic random-access memory (DRAM) devices. Method 800 also includes, in 820, receiving a burst data transaction on data signals of a memory controller. Method 800 also includes, in 830, interleaving a first portion of the burst data transaction across a first pair of the four pseudo-channels. Method 800 also includes, in 840, interleaving a second portion of the burst data transaction across a second pair of the four pseudo-channels.

In the following, various examples are provided that may include one or more aspects described above with reference to interleaving two pseudo channels and/or any of FIGS. 1-8. The examples provided in relation to the devices may apply also to the described method(s), and vice versa.

Example 011 is a device including a printed circuit board (PCB). The device also includes a plurality of dynamic random-access memory (DRAM) devices arranged on the PCB and logically divided into four pseudo-channels. The device also includes a shared command/address (C/A) bus configured to transmit command signals to all four pseudo-channels. The device also includes a set of multiplexers controllable to selectively couple data signals between the four pseudo-channels and a memory controller. The device also includes a control interface configured to interleave data burst transactions of the data signals across the four pseudo-channels, wherein a burst of the data burst transactions is distributed across two groups, each group including two of the four pseudo-channels operating in parallel.

Example 122 is the device of example 1, wherein each pseudo-channel includes a set of 8-bit DRAM devices operating at one-fourth of a full data rate of the data signals.

Example 3 is the device of any one of examples 1 to 22, wherein the device is a memory module.

Example 4 is the device of any one of examples 1 to 23, wherein the plurality of DRAM devices operate in byte mode.

Example 5 is the device of any one of examples 1 to 24, wherein a burst length of the data signals is sixteen (e.g., BL16), where each group of the two groups is configured to handle eight consecutive beats of the burst.

Example 6 is the device of any one of examples 1 to 25, wherein the shared command/address bus is seven bits wide and time-multiplexed among the pseudo-channels.

Example 7 is the device of any one of examples 1 to 26, the device further including two chip-select (e.g., CS #) signals configured to select between the two groups.

Example 8 is the device of any one of examples 1 to 27, wherein each of the plurality of DRAM devices include low power double data-rate (LPDDR) memory chips in a 315-ball byte-mode package.

Example 9 is the device of any one of examples 1 to 28, wherein the multiplexer is configured to dynamically select one of the two groups of pseudo-channels for interleaved access based on a first portion of a burst, wherein the multiplexer is further configured to dynamically select the other of the two groups based on a second portion of the burst.

Example 10 is the device of any one of examples 1 to 29, wherein each pseudo-channel includes five LPDDR devices.

Example 11 is the device of examples 210, wherein each LPDDR device includes 8 bits, wherein the five LPDDR devices together provide a 40-bit data width for the data signals.

Example 12 is the device of any one of examples 1 to 211, wherein the plurality of DRAM devices are arranged on a first side of the PCB, wherein the device further includes a second plurality of DRAM devices arranged on a second side of the PCB that are logically divided into an additional four pseudo-channels.

Example 21313 is a method including transmitting command and address signals to four pseudo-channels of a memory module via a shared command/address bus, each pseudo-channel including a plurality of dynamic random-access memory (DRAM) devices. The method also includes receiving a burst data transaction on data signals of a memory controller. The method also includes interleaving a first portion of the burst data transaction across a first pair of the four pseudo-channels. The method also includes interleaving a second portion of the burst data transaction across a second pair of the four pseudo-channels.

Example 131414 is the method of example 13, the method further including operating the DRAM devices at one-fourth of a full data rate of the data signals.

Example 15 is the method of any one of examples 13 to 1414, wherein each pseudo-channel includes five 8 bit DRAM devices operating in byte mode.

Example 16 is the method of any one of examples 13 to 1415, the method further including operating the plurality of DRAM devices in byte mode.

Example 17 is the method of any one of examples 13 to 1416, wherein a burst length of the data signals is sixteen (e.g., BL16), where each group of the two groups handles eight consecutive beats of the burst.

Example 18 is the method of any one of examples 13 to 1417, wherein the shared command/address bus is seven bits wide and time-multiplexed among the pseudo-channels.

Example 19 is the method of any one of examples 13 to 1418, the method further including selecting between the two groups based on chip-select (e.g., CS #) signals.

Example 20 is the method of any one of examples 13 to 1419, wherein each of the plurality of DRAM devices include low power double data-rate (LPDDR) memory chips in a 315-ball byte-mode package.

Example 21 is the method of any one of examples 13 to 1420, the method further including dynamically selecting one of the two groups of pseudo-channels for interleaved access during a first portion of a burst, the method further including dynamically selecting the other of the two groups during a second portion of the burst.

Example 22 is the method of any one of examples 13 to 1421, wherein each pseudo-channel includes five LPDDR devices.

Example 23 is the method of examples 1422, wherein each LPDDR device includes 8 bits, wherein the five LPDDR devices together provide a 40-bit data width for the data signals.

Example 142424 is an apparatus including a means for transmitting command and address signals to four pseudo-channels of a memory module via a shared command/address bus, each pseudo-channel including a plurality of dynamic random-access memory (DRAM) devices. The apparatus also includes a means for receiving a burst data transaction on data signals of a memory controller. The apparatus also includes a means for interleaving a first portion of the burst data transaction across a first pair of the four pseudo-channels. The apparatus also includes a means for interleaving a second portion of the burst data transaction across a second pair of the four pseudo-channels.

Example 242525 is the apparatus of example 24, the apparatus further including a means for operating the DRAM devices at one-fourth of a full data rate of the data signals.

Example 26 is the apparatus of any one of examples 24 to 2525, wherein each pseudo-channel includes five 8 bit DRAM devices operating in byte mode.

Example 27 is the apparatus of any one of examples 24 to 2526, the apparatus further including a means for operating the plurality of DRAM devices in byte mode.

Example 28 is the apparatus of any one of examples 24 to 2527, wherein a burst length of the data signals is sixteen (e.g., BL16), where each group of the two groups handles eight consecutive beats of the burst.

Example 29 is the apparatus of any one of examples 24 to 2528, wherein the shared command/address bus is seven bits wide and time-multiplexed among the pseudo-channels.

Example 30 is the apparatus of any one of examples 24 to 2529, the apparatus further including a means for selecting between the two groups based on chip-select (e.g., CS #) signals.

Example 31 is the apparatus of any one of examples 24 to 2530, wherein each of the plurality of DRAM devices include low power double data-rate (LPDDR) memory chips in a 315-ball byte-mode package.

Example 32 is the apparatus of any one of examples 24 to 2531, the apparatus further including a means for dynamically selecting one of the two groups of pseudo-channels for interleaved access during a first portion of a burst, wherein the multiplexer is further configured to dynamically select the other of the two groups during a second portion of the burst.

Example 33 is the apparatus of any one of examples 24 to 2532, wherein each pseudo-channel includes five LPDDR devices.

Example 34 is the apparatus of examples 2533, wherein each LPDDR device includes 8 bits, wherein the five LPDDR devices together provide a 40-bit data width for the data signals.

Example 253535 is a non-transitory computer readable medium including instructions, that when executed by one or more processors, cause the one or more processors to transmit command and address signals to four pseudo-channels of a memory module via a shared command/address bus, each pseudo-channel including a plurality of dynamic random-access memory (DRAM) devices. The instructions also cause the one or more processors to receive a burst data transaction on data signals of a memory controller, the burst data transaction distributed across two groups, each group comprising two of the four pseudo-channels operating in parallel. The instructions also cause the one or more processors to interleave a first portion of the burst data transaction across a first pair of the four pseudo-channels. The instructions also cause the one or more processors to interleave a second portion of the burst data transaction across a second pair of the four pseudo-channels.

Example 353636 is the non-transitory computer readable medium of example 35, wherein the instructions also cause the one or more processors to operate the DRAM devices at one-fourth of a full data rate of the data signals.

Example 37 is the non-transitory computer readable medium of any one of examples 35 to 3636, wherein each pseudo-channel includes five 8 bit DRAM devices operating in byte mode.

Example 38 is the non-transitory computer readable medium of any one of examples 35 to 3637, wherein the instructions also cause the one or more processors to operate the plurality of DRAM devices in byte mode.

Example 39 is the non-transitory computer readable medium of any one of examples 35 to 3638, wherein a burst length of the data signals is sixteen (e.g., BL16), where each group of the two groups handles eight consecutive beats of the burst.

Example 40 is the non-transitory computer readable medium of any one of examples 35 to 3639, wherein the shared command/address bus is seven bits wide and time-multiplexed among the pseudo-channels.

Example 41 is the non-transitory computer readable medium of any one of examples 35 to 3640, where in the instructions also cause the one or more processors to select between the two groups based on chip-select (e.g., CS #) signals.

Example 42 is the non-transitory computer readable medium of any one of examples 35 to 3641, wherein each of the plurality of DRAM devices include low power double data-rate (LPDDR) memory chips in a 315-ball byte-mode package.

Example 43 is the non-transitory computer readable medium of any one of examples 35 to 3642, wherein the instructions also cause the one or more processors to dynamically selecting one of the two groups of pseudo-channels for interleaved access during a first portion of a burst, wherein the multiplexer is further configured to dynamically select the other of the two groups during a second portion of the burst.

Example 44 is the non-transitory computer readable medium of any one of examples 35 to 3643, wherein each pseudo-channel includes five LPDDR devices.

Example 45 is the non-transitory computer readable medium of examples 3644, wherein each LPDDR device includes 8 bits, wherein the five LPDDR devices together provide a 40-bit data width for the data signals.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising:
a printed circuit board (PCB);
a plurality of dynamic random-access memory (DRAM) devices arranged on the PCB and logically divided into four pseudo-channels;
a shared command/address bus configured to transmit command signals to all four pseudo-channels;
a set of multiplexers controllable to selectively couple data signals between the four pseudo-channels and a memory controller; and
a control interface configured to interleave data burst transactions of the data signals across the four pseudo-channels, wherein a burst of the data burst transactions is distributed across two groups, each group comprising two of the four pseudo-channels operating in parallel.

2. The device of claim 1, wherein each pseudo-channel comprises a set of 8-bit DRAM devices operating at one-fourth of a full data rate of the data signals.

3. The device of claim 1, wherein the device is a memory module.

4. The device of claim 1, wherein the plurality of DRAM devices operate in byte mode.

5. The device of claim 1, wherein a burst length of the data signals is sixteen, where each group of the two groups is configured to handle eight consecutive beats of the burst.

6. The device of claim 1, wherein the shared command/address bus is seven bits wide and time-multiplexed among the pseudo-channels.

7. The device of claim 1, the device further comprising two chip-select signals configured to select between the two groups.

8. The device of claim 1, wherein each of the plurality of DRAM devices comprise low power double data-rate (LPDDR) memory chips in a 315-ball byte-mode package.

9. The device of claim 1, wherein the multiplexer is configured to dynamically select one of the two groups of pseudo-channels for interleaved access based on a first portion of a burst, wherein the multiplexer is further configured to dynamically select the other of the two groups based on a second portion of the burst.

10. The device of claim 1, wherein each pseudo-channel comprises five LPDDR devices.

11. The device of claim 210, wherein each LPDDR device comprises 8 bits, wherein the five LPDDR devices together provide a 40-bit data width for the data signals.

12. The device of claim 1, wherein the plurality of DRAM devices are arranged on a first side of the PCB, wherein the device further comprises a second plurality of DRAM devices arranged on a second side of the PCB that are logically divided into an additional four pseudo-channels.

21313. A non-transitory computer-readable medium comprising instructions, that, when executed by one or more processors, cause the one or more processors to:
transmit command and address signals to four pseudo-channels of a memory module via a shared command/address bus, each pseudo-channel comprising a plurality of dynamic random-access memory (DRAM) devices;
receive a burst data transaction on data signals of a memory controller, the burst data transaction distributed across two groups, each group comprising two of the four pseudo-channels operating in parallel;
interleave a first portion of the burst data transaction across a first pair of the four pseudo-channels; and
interleave a second portion of the burst data transaction across a second pair of the four pseudo-channels.

131414. The non-transitory computer-readable medium of claim 13, further comprising operating the DRAM devices at one-fourth of a full data rate of the data signals.

15. The non-transitory computer-readable medium of claim 13, wherein each pseudo-channel comprises five 8 bit DRAM devices operating in byte mode.

16. The non-transitory computer-readable medium of claim 13, further comprising operating the plurality of DRAM devices in byte mode.

17. The non-transitory computer-readable medium of claim 13, wherein a burst length of the data signals is sixteen, where each group of the two groups handles eight consecutive beats of the burst.

18. The non-transitory computer-readable medium of claim 13, wherein the shared command/address bus is seven bits wide and time-multiplexed among the pseudo-channels.

141919. A method comprising:
transmitting command and address signals to four pseudo-channels of a memory module via a shared command/address bus, each pseudo-channel comprising a plurality of dynamic random-access memory devices;
receiving a burst data transaction on data signals of a memory controller;
interleaving a first portion of the burst data transaction across a first pair of the four pseudo-channels; and
interleaving a second portion of the burst data transaction across a second pair of the four pseudo-channels.

192020. The method of claim 19, the method further comprising dynamically selecting one of the two groups of pseudo-channels for interleaved access during a first portion of a burst, the method further comprising dynamically selecting the other of the two groups during a second portion of the burst.
